(19) United States
(12) Patent Application Publication
(10) Pub. No.: US 2023/0192290 A1
(43) Pub. Date: Jun. 22, 2023

(54) UAV WITH AUGMENTED LIFT ROTORS

(71) Applicant: WING Aviation LLC, Mountain View, CA (US)

(72) Inventors: Adam Woodworth, San Jose, CA (US); Giulia B. Pantalone, Redwood City, CA (US); Luis Prado, Mountain View, CA (US); Michelle Suen, Sunnyvale, CA (US)

(21) Appl. No.: 17/554,371

(22) Filed: Dec. 17, 2021

(51) Int. Cl. B64C 39/02; B64C 27/26; B64C 27/32; B64C 11/00; B64C 27/30; B64C 27/80; G05D 1/10

(52) U.S. Cl. CPC B64C 39/024; B64C 27/26; B64C 27/325; B64C 11/00; B64C 27/30; B64C 27/80; G05D 1/102; B64C 2201/02; B64C 2201/108; B64C 2201/104; B64C 2201/165

(57) ABSTRACT

An unmanned aerial vehicle (UAV) includes lift rotors and control rotors. The lift rotors are mounted to the UAV and oriented to provide a first vertical thrust to the UAV. The control rotors are mounted to the UAV outboard of the lift rotors and oriented to provide a second vertical thrust to the UAV. The control rotors are each smaller than any of the lift rotors.

### TECHNICAL FIELD

This disclosure relates generally to unmanned aerial vehicles, and in particular but not exclusively, relates to vertical lift propulsion for unmanned aerial vehicles.

### BACKGROUND INFORMATION

An unmanned aerial vehicle (UAV), which may be referred to as an autonomous aerial vehicle or drone, is an aerial vehicle capable of travel without a physically present human operator. A UAV may operate in a remote-control mode, in a fully autonomous mode, or in a partially autonomous mode. Various types of UAV exist for different applications or mission types. For instance, UAVs may be used for recreation, aerial photography, public safety, package delivery, etc. Package delivery is becoming an increasing important commercial application for UAVs. Conventional UAVs are suitable for delivering small, lightweight, packages due to payload constraints. As UAV designs are refined and their capabilities expanded, UAV suitability for commercial use is expected to expand. Designs that increase payloads while retaining compact, efficient, and/or safe form factors will expand UAV mission capabilities and ultimately accelerate marketplace adoption.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates a fleet of unmanned aerial vehicles (UAVs) staged at a terminal area for providing UAV services to a neighborhood, in accordance with an embodiment.

FIGS. 2A & 2B are perspective view illustrations of a UAV having augmented lift capabilities provided by lift rotors and control rotors, in accordance with an embodiment of the disclosure.

FIG. 3 illustrates inward or outward canting of the control rotors providing increased attitude control over the UAV, in accordance with an embodiment of the disclosure.

FIG. 4A is a perspective view illustration of a UAV having augmented lift capability with dual nose propellers for forward cruise flight, in accordance with an embodiment of the disclosure.

FIG. 4B is a perspective view illustration of a UAV having augmented lift capability with nose and tail propellers for forward cruise flight, in accordance with an embodiment of the disclosure.

### DETAILED DESCRIPTION

Embodiments of a system, apparatus and method of operation for an unmanned aerial vehicle (UAV) having augmented lift capabilities are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

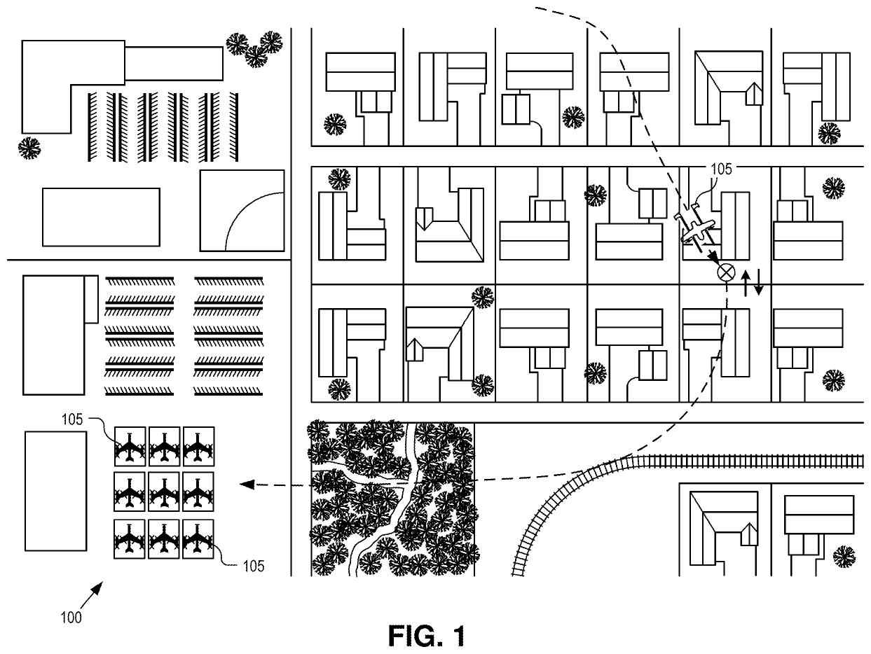

Expanding the payload capacity of UAVs while maintaining a compact, safe form factor is desirable. UAVs are expected to increasingly become an important component in package delivery logistics, particularly for the final 10 miles (or more) to service not only wide-open rural communities, but also denser suburb or even urban neighborhoods. FIG. 1 illustrates an example terminal area 100 staging a plurality of UAVs, such as UAVs 105, for servicing a nearby neighborhood. It is expected that terminal areas, such as terminal area 100, may eventually be located to realize UAV aerial deliveries of small and medium sized packages to suburban and/or urban neighborhoods. As shopping habits and patterns of these communities increasingly move to online purchases, safely expanding UAV payload capacity will enable UAVs to deliver a greater portion of these packages into these communities. However, due to habitation density and the presence of numerous obstacles in these communities, simply increasing the size of conventional UAVs to accommodate larger packages may not be feasible or appropriate. Regardless, a smaller form factor for UAVs 105 reduces storage size of the UAVs, reduces shipping size of the UAVs themselves when transporting UAVs to terminal areas 100, and reduces overall drag during forward cruise flight for improved operational efficiency. Providing any or all of the above benefits while maintaining or even increasing payload capacity can help accelerate marketplace adoption of UAVs for aerial package delivery systems.

Accordingly, embodiments described herein present a UAV architecture/design that augments the lifting capability of a fixed wing UAV. A fixed wing design generates lift from the aerodynamic shape of the fixed wings during forward cruise flight. However, the augmented lift described herein provides more efficient vertical thrust during vertical ascents, vertical descents, or stationary hover. The illustrated embodiments are fixed wing aircraft that provide an efficient cruise mode while being capable of vertical take-off and landing (VTOL) to facilitate package deliveries in congested locations. The design enables the use of larger vertical thrust rotors that provide more efficient thrust. The design achieves this increased or augmented lift while maintaining a compact form factor by placing lift rotors inboard closer to the fuselage. For example, the lift rotors may be placed under the fixed wings to reduce (or eliminate in some embodiments) the rotor blades extending out past the wing tips. This inboard location not only enables use of larger more efficient lift rotor blades, but reduces the overall size of the UAV, potentially improving safety by reducing the likelihood the larger rotor blades can inadvertently make contact with an external object during flight. The smaller, safer form factor improves the UAV's agility and ability to navigate in the tighter environments of suburban and urban neighborhoods while increasing payload capabilities.

Embodiments described herein further include the use of smaller control rotors placed outboard (e.g., greater lateral distance from the center of the aerial vehicle) of the lift rotors increasing their lever arm from the UAV's center of mass thereby providing improved attitude control over the UAV (compared to the more protected lift rotors) for a given amount of generated thrust. Since the control rotor blades are smaller, they do not extend out past the airframe or wings as far as the lift rotor blades would if the lift rotors blades were pushed to the outboard position. The smaller diameter rotor blades themselves are inherently safer having less momentum and reduced contact area in the event of a midflight collision between the UAV and an external object.

Although the augmented lift architecture described herein is well suited for fixed wing aircraft having horizontal propulsion systems, and the illustrated embodiments are also all fixed wing aircraft, the described architecture using larger inboard lift rotors with a greater number of smaller outboard control rotors may be used in connection with other types of VTOL UAVs that do not include fixed wings for generating aerodynamic lift. For example, the fixed wings may be replaced with boom structures that extend out from the fuselage on opposing sides, but these boom structures need not have an aerodynamic shape that generates lift.

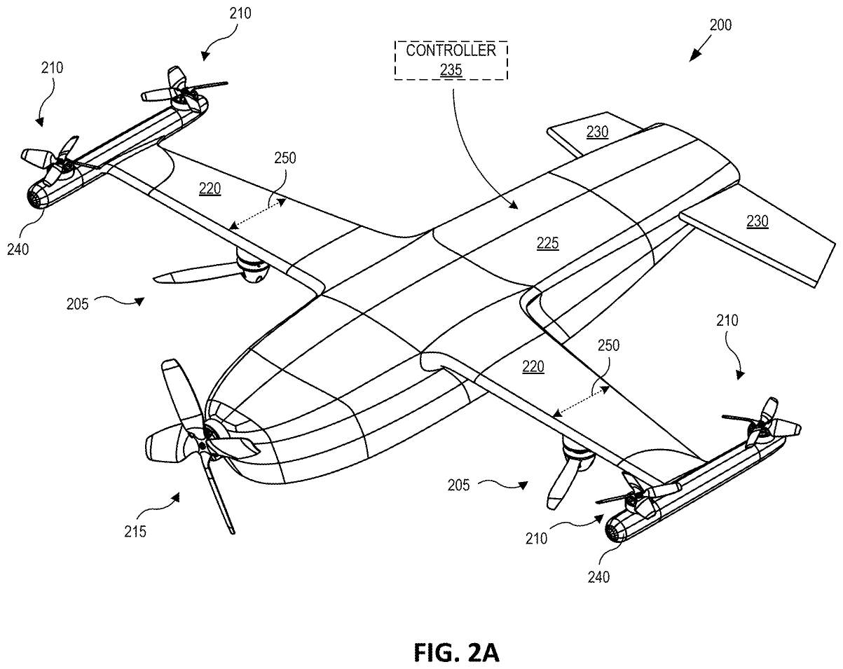

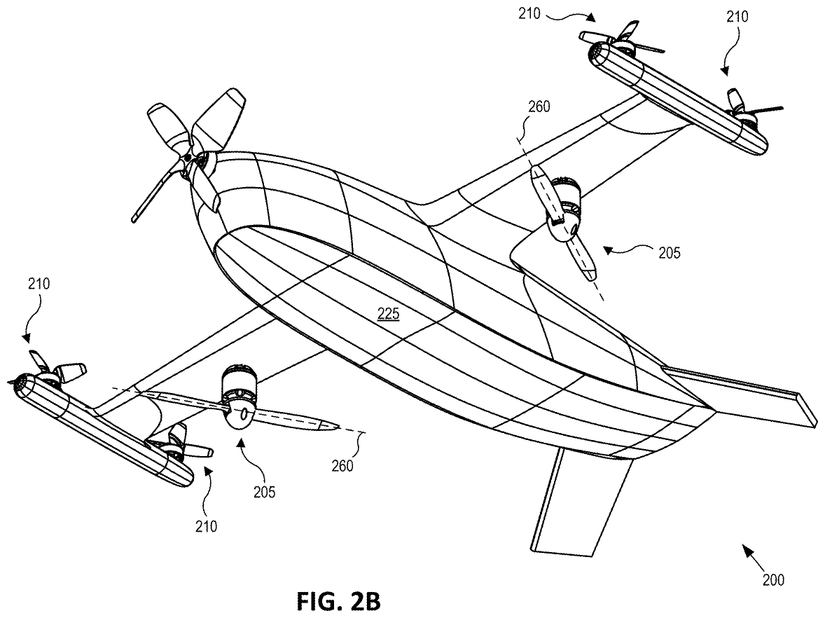

FIGS. 2A & 2B are perspective view illustrations of a UAV 200 having augmented lift capabilities provided by lift rotors 205 and control rotors 210, in accordance with an embodiment of the disclosure. FIG. 2A is a topside perspective view illustration of UAV 200 while FIG. 2B is a bottom side perspective view illustration of the same. UAV 200 is one possible implementation of UAVs 105 illustrated in FIG. 1. UAV 200 is well-suited for package delivery as well as other mission types including aerial photography, public safety, etc.

The illustrated embodiment of UAV 200 is a VTOL UAV that includes a horizontal propulsion system (e.g., nose propeller 215) that is separate/distinct from a vertical propulsion system (e.g., lift rotors 205 and control rotors 210). The illustrated embodiment of UAV 200 is a fixed-wing aerial vehicle, which as the name implies, has fixed wings 220 that extend out from either side of fuselage 225. Fixed wings 220 have aerodynamic shapes that generate lift during forward cruise flight of UAV 200. The amount of lift generated is not only based upon the size and shape of fixed wings 220 but also the aircraft's forward airspeed when propelled forward by its horizontal propulsion system (e.g., nose propeller 215). UAV 200 has an airframe that includes fuselage 225 and fixed wings 220. In one embodiment, fuselage 225 is modular and includes a battery module, an avionics module, and a mission payload module. These modules are secured together to form fuselage 225 (i.e., the main body) and collectively house the UAV's electronics.

The battery module (e.g., fore portion of fuselage 225) includes a cavity for housing electronics including one or more batteries for powering UAV 200. The avionics module (e.g., aft portion of fuselage 225) houses various electronics including flight control circuitry (e.g., controller 235), which may include a processor and memory, communication electronics and antennas (e.g., cellular transceiver, wifi transceiver, etc.), and various sensors (e.g., global positioning sensor, an inertial measurement unit, a magnetic compass, a radio frequency identifier reader, etc.). The mission payload module (e.g., middle portion of fuselage 225) houses equipment associated with a mission of UAV 200. For example, the mission payload module may include a payload actuator (e.g., an actuated hook and tether) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). The above three module functional delineation between sections of fuselage 225 is merely demonstrative. In other embodiments, the various functional components may be combined into more or less distinct fuselage modules and the fore-to-aft ordering of these modules within fuselage 225 may be reversed or otherwise reordered.

As mentioned above, FIGS. 2A and 2B illustrates an example VTOL, fixed wing aircraft capable of hovering, vertical ascents and descents, and efficient forward cruise flight that achieves aerodynamic lift to sustain forward flight while disabling and/or stowing the vertical propulsion system (i.e., lift rotors 205 and control rotors 210). The vertical propulsion system may be used during a hover mode where UAV 200 is descending (e.g., to a delivery location), ascending (e.g., at initial launch or following a delivery), maintaining a constant altitude, or translating at low speed. Stabilizers 230 (or tails) may be included with UAV 200 to control pitch (rotation about the horizontal axis that extends laterally from the center of the aircraft along the length of the wing) and stabilize the aerial vehicle in yaw (left or right rotations about its vertical axis) during cruise. Control surfaces on the wings or tails may be used to control roll (rotation about the axis of the aircraft from nose to tail) during cruise. In some embodiments, during cruise mode the vertical propulsion system is disabled or powered low and during hover mode the horizontal propulsion system may be disabled or powered low. Of course, gradual transitions between the cruise and hover may be implemented.

During flight, UAV 200 may control the direction and/or speed of its movement by controlling its pitch, roll, yaw, and/or altitude. Thrust from the horizontal propulsion system (e.g., nose propeller 215) is used to control air speed. Stabilizers 230 may include one or more rudders (not illustrated) for controlling the aerial vehicle's yaw and/or elevators (not illustrated) for controlling the aerial vehicle's pitch, and fixed wings 220 may include ailerons (not illustrated) for controlling the aerial vehicle's roll. As another example, increasing or decreasing thrust from the nose propeller can also result in UAV 200 increasing or decreasing its altitude via control of aerodynamic lift. While FIGS. 2A and 2B illustrated an A-shaped tail assembly, other types/shapes of tail assemblies may be implemented.

The vertical propulsion system includes lift rotors 205 mounted to fixed wings 220 on either side of fuselage 225. The vertical propulsion system further includes control rotors 210 mounted to UAV 200 via fixed wings 220 outboard of lift rotors 205. Control rotors 210 are each smaller than any of lift rotors 205. In other words, the diameter of control rotors 210 is smaller than the diameter of lift rotors 205. For example, control rotors 210 may be 5″ or 6″ in diameter while lift rotors 205 may be 15″ in diameter. Of course, other dimensions may be implemented depending upon the particular UAV application. In the illustrated embodiment, the horizontal propulsion system includes a propeller (e.g., nose propeller 215) mounted to fuselage 225 laterally inboard of lift rotors 205.

In the illustrated embodiment, lift rotors 205 are mounted inboard closer to fuselage 225 than control rotors 210 to provide extra room for the larger rotor blades while sheltering them within the overall profile of the airframe. This reduces the overall form factor of UAV 200 while also providing increased safety and resilience from midair collisions. Safety is increased since the smaller rotor blades of control rotors 210 do not extend out as far from the airframe and typically have less momentum when spinning relative to the larger blades of lift rotors 205. Resilience from collisions is increased because the smaller control rotors don't extend out as far from the airframe and thus are less likely to experience a collision and UAV 200 may be able to lose one or two control rotors 210 while still maintaining control authority whereas a failure of a lift rotor 205 during hover could be less recoverable.

The larger diameter of lift rotors 205 provides more efficient lifting thrust relative to a smaller diameter configuration, thereby providing an augmented lifting capability. The outboard position of control rotors 210 increases attitude control authority compared to the inboard position of lift rotors 205 for a given amount of thrust. In the illustrated embodiment, the vertical propulsion system includes two lift rotors and four control rotors 210 though more or less control rotors 210 may be implemented. During typical hover operation, lift rotors 205 may be collectively driven by controller 235 to provide 60-75% of the total lifting thrust while control rotors 210 may be collectively driven to provide 25-40% of the total lifting thrust at a given moment during hover mode.

In the illustrated embodiment, lift rotors 205 are mounted beneath fixed wings 220 while control rotors 210 are mounted above fixed wings 220. Lift rotors 205 are mounted directly to the underside of fixed wings 220 while control rotors 210 are mounted to wing booms 240, which in turn extend from fixed wings 220. Wing booms 240 extend fore and aft of fixed wings 220 enabling control rotors 210 to be spread fore and aft to provide multi-axis attitude control over UAV 200. Although wing booms 240 are illustrated as extending from the wing tips, in other embodiments, wing booms 240 may mount to a midspan location between fuselage 225 and the wing tip. Although FIGS. 2A and 2B illustrated two underwing lift rotors 205 and four above-wing control rotors 210, other combinations and configurations may be implemented. For example, control rotors 210 may be mounted directly to fixed wings 220 without use of wing booms 240. Alternatively, three or four control rotors may be mounted to each wing boom 240. Similarly, multiple lift rotors 205 may be mounted to, or under, each fixed wing 220. Furthermore, the boom length or ratio of boom length to fixed wing length may be greater or less than what is illustrated in the figures.

As mentioned, the rotor blades of lift rotors 205 are larger than the rotor blades of control rotors 210, providing more efficient thrust generation to the larger lift rotors 205. For example, lift rotor blades may be 15″ in diameter while control rotors blades may be 5″ or 6″ in diameter. These dimensions may vary depending upon the specific UAV application; however, in general the diameter of the lift rotor is expected to be larger than the wing chord 250 at the mounting location of lift rotors 205 on fixed wings 220 for improved airflow. In the illustrated embodiment, each control rotor 210 has more rotor blades than each lift rotor 205. For example, control rotors 210 may have three or four (illustrated) rotor blades per rotor while lift rotors 205 have two. The larger rotor blade count for control rotors 210 reduces their diameter thereby reducing the extent at which control rotors 210 extend out past the airframe footprint. Correspondingly, the dual blade design of lift rotors 205 enables the larger lift rotors 205 to be positioned into a low drag orientation during forward cruise flight when lift rotors 205 are idle or not spinning. For a dual blade configuration, lift rotors 205 may be actively aligned under the influence of controller 235 such that their smallest cross-sectional shape is pointed forward. In other words, the longitudinal axis 260 extending through both rotor blades is aligned parallel with the airflow to present a smaller cross-section to the wing for reduced drag. In other embodiments, pivoting rotor blades may be used that passively foldback when the rotor is idle to assume a low drag orientation during forward cruise flight.

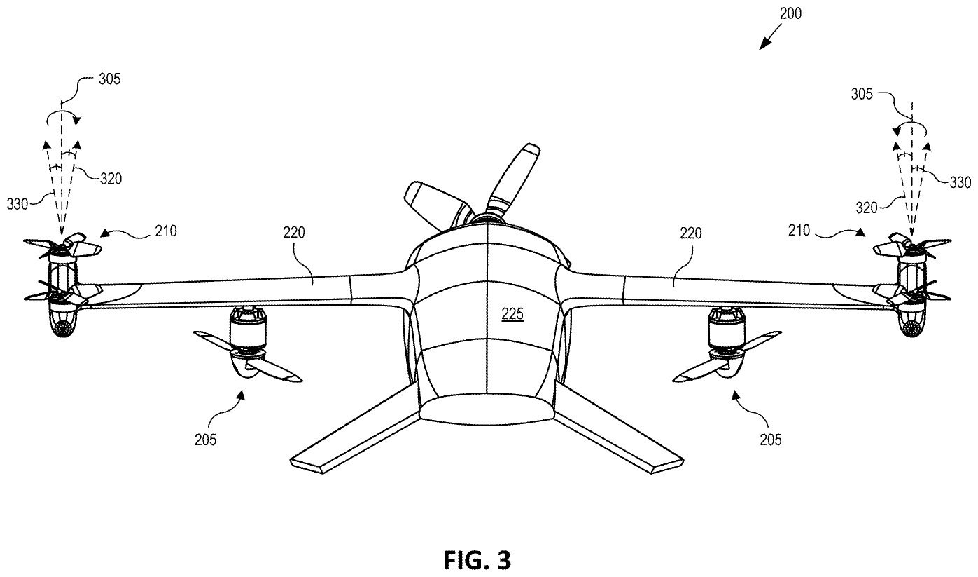

Control rotors 210 are provided in the outboard position (in part) to increase their effectiveness over attitude control. However, turning to FIG. 3, in some embodiments control rotors 210 are also canted to further increase their effectiveness at influencing the aircraft's attitude. For example, rotational axes 305 about which control rotors 210 spin may be canted either inward towards fuselage 225 (position 320) or outward away from fuselage 225 (position 330). The lateral cant may be relatively small (e.g., 5 degrees), but can provide increased attitude control while sacrificing a modest portion of the overall vertical thrust provided by the vertical propulsion system.

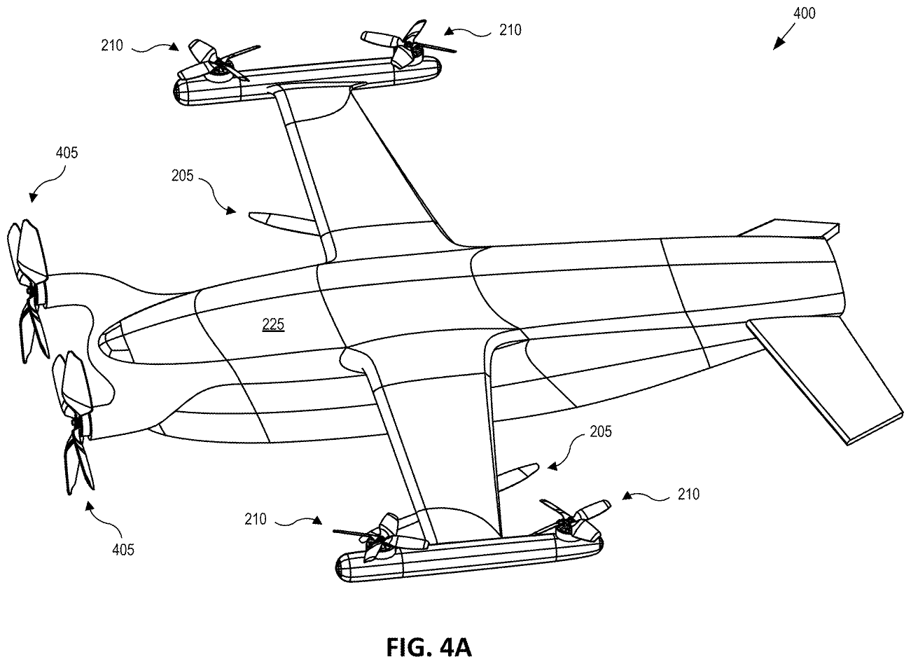

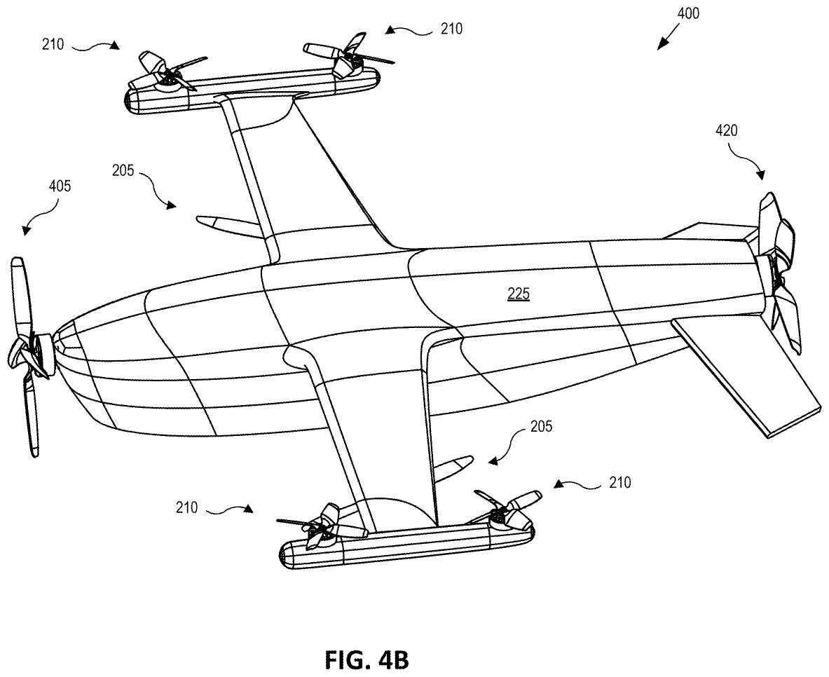

Many variations on the illustrated fixed-wing aerial vehicle are possible. For instance, aerial vehicles with more wings (e.g., an “x-wing” configuration with four wings), are also possible. Although FIGS. 2A and 2B illustrate just two fixed wings 220, two wing booms 240, a single horizontal propeller (e.g., nose propeller 215), and six vertical thrust rotors (e.g., lift rotors 205 and control rotors 210), it should be appreciated that other variants of UAV 200 may be implemented with more or less of these components. For example, FIG. 4A illustrates a UAV 400 that is similar to UAV 200, but includes a horizontal propulsion system having two smaller nose propellers 405 mounted to fuselage 225. Alternatively, FIG. 4B illustrates a UAV 401 that is also similar to UAV 200, but includes a horizontal propulsion system having a single large nose propeller 415 and a tail propeller 420 mounted to fuselage 225.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An unmanned aerial vehicle (UAV), comprising:
a fuselage;
fixed wings extending out from either side of the fuselage, wherein the fixed wings have aerodynamic shapes that generate lift during a forward cruise flight;
a horizontal propulsion system oriented to provide a forward thrust; and
a vertical propulsion system including:
lift rotors each mounted to a corresponding one of the fixed wings on respective sides of the fuselage and oriented to provide a first vertical thrust to the UAV; and
control rotors mounted to the UAV via the fixed wings outboard of the lift rotors and oriented to provide a second vertical thrust to the UAV, wherein the control rotors are each smaller than any of the lift rotors.

2. The UAV of claim 1, wherein the vertical propulsion system includes two of the lift rotors and four of the control rotors, wherein all of the control rotors are mounted outboard of the lift rotors providing increased attitude control over the UAV compared to the lift rotors for a given amount of thrust.

3. The UAV of claim 1, wherein the lift rotors are mounted beneath the fixed wings.

4. The UAV of claim 3, wherein the control rotors are mounted above the fixed wings.

5. The UAV of claim 1, wherein the control rotors are mounted directly to wing booms extending fore and aft from the fixed wings.

6. The UAV of claim 5, wherein the wing booms extend fore and aft from wing tips of the fixed wings.

7. The UAV of claim 1, wherein the horizontal propulsion system comprises at least one horizontal thrust propeller mounted to the fuselage laterally inboard of lift rotors.

8. The UAV of claim 1, further comprising a controller disposed within the fuselage and including logic that when executed by the controller causes the UAV to perform operations comprising:
spinning the lift rotors to generate the first vertical thrust during vertical ascent, vertical descent, or hover of the UAV; and
actively aligning rotor blades of the lift rotors into a low drag orientation for the forward cruise flight when the lift rotors are not spinning.

9. The UAV of claim 1, further comprising a controller disposed within the fuselage and including logic that when executed by the controller causes the UAV to perform operations comprising:
allocating between 60 and 75 percent of a total vertical thrust generated by the vertical propulsion system at a given time to the lift rotors; and
allocating between 40 and 25 percent of the total vertical thrust generated by the vertical propulsion system at the given time to the control rotors.

10. The UAV of claim 1, wherein rotational axes of the control rotors are canted either inward towards the fuselage or outward away from the fuselage.

11. The UAV of claim 1, wherein a diameter of the lift rotors is greater than chords of the fixed wings at mounting locations of the lift rotors.

12. The UAV of claim 1, wherein the control rotors each have a blade count that is greater than each of the lift rotors.

13. An unmanned aerial vehicle (UAV) comprising:
lift rotors mounted to the UAV and oriented to provide a first vertical thrust to the UAV; and
control rotors mounted to the UAV outboard of the lift rotors and oriented to provide a second vertical thrust to the UAV, wherein the control rotors are each smaller than any of the lift rotors.

14. The UAV of claim 13, wherein the UAV includes two of the lift rotors and four of the control rotors, wherein all of the control rotors are mounted outboard of the lift rotors.

15. The UAV of claim 13, further comprising:
a fuselage;
fixed wings extending from either side of the fuselage, wherein the lift rotors and control rotors are mounted to the UAV via the fixed wings.

16. The UAV of claim 15, wherein the lift rotors are mounted beneath the fixed wings and the control rotors are mounted above the fixed wings.

17. The UAV of claim 16, wherein the control rotors are mounted to wing booms extending fore and aft from the fixed wings while the lift rotors are mounted directly to the fixed wings.

18. The UAV of claim 15, wherein a diameter of the lift rotors is greater than chords of the fixed wings at mounting locations of the lift rotors.

19. The UAV of claim 13, further comprising:
at least one horizontal thrust propeller mounted laterally inboard of lift rotors to propel forward cruise flight; and
a controller including logic that when executed by the controller causes the UAV to perform operations comprising:
spinning the lift rotors to generate the first vertical thrust during vertical ascent, vertical descent, or hover of the UAV; and
actively aligning rotor blades of the lift rotors into a low drag orientation for the forward cruise flight when the lift rotors are not spinning.

20. The UAV of claim 13, wherein rotational axes of the control rotors are canted either inward towards the fuselage of the UAV or outward away from the fuselage while the lift rotors are not canted.

21. The UAV of claim 13, wherein the control rotors each have a greater blade count than each of the lift rotors.
